(19) United States
(12) Patent Application Publication
(10) Pub. No.: US 2023/0201798 A1
(43) Pub. Date: Jun. 29, 2023

(54) MATERIAL AND METHOD FOR REMEDIATION OF A SITE CONTAMINATED BY AN OIL SPILL

(71) Applicant: Recoil Oil Recovery Pty Ltd, Hunters Hill, New South Wales (AU)

(72) Inventors: David Robert Guthrie, Marsfield, New South Wales (AU); Ernest Beresford Peter Hall, Paddington, New South Wales (AU)

(21) Appl. No.: 17/928,311

(22) PCT Filed: May 27, 2021
(86) PCT No.: PCT/AU2021/050512

§ 371 Date: Nov. 29, 2022

(30) Foreign Application Priority Data
May 29, 2020 (AU) 2020901778

(51) Int. Cl. B01J 20/26; C09K 3/32; B01J 20/24; B01J 20/20; B01J 20/08; B01J 20/02; B01J 20/28; B01J 20/30; C02F 1/28; B01D 17/02; E02B 15/10

(52) U.S. Cl. CPC B01J 20/261; C09K 3/32; B01J 20/262; B01J 20/24; B01J 20/20; B01J 20/08; B01J 20/0244; B01J 20/0274; B01J 20/28016; B01J 20/28004; B01J 20/2805; B01J 20/3028; B01J 20/3064; C02F 1/285; B01D 17/0202; E02B 15/101; C02F 2303/16; C02F 2101/32

(57) ABSTRACT

Disclosed herein is an apparatus (10) for remediation of a site contaminated by an oil spill. The apparatus (10) comprises a porous capsule (12) encapsulating material (14) for sorbing oil. The material (14) comprises granules of an at least semi-open cell polymeric foam, the granules being less than 10cm3 in size. Ingredients from which the polymeric foam is formed comprise acrylonitrile butadiene rubber as a major constituent thereof by weight.

### CROSS-REFERENCE

The present application claims priority from Australian Patent Application No 2020901778, which was filed on 29 May 2020, the contents of which are incorporated herein by reference in their entirety.

### TECHNICAL FIELD

This specification discloses a material and method for remediation of a site contaminated by an oil spill.

### BACKGROUND

Contamination of bodies of water and soil due to spillage of petroleum hydrocarbons (“oil spills”) is a significant environmental issue. Oil spills, especially large spills, in waterways typically result in death or significant harm to fish, birds and other marine life, including marine vegetation. Similar environmental impacts also arise when soil is contaminated by an oil spill.

Remediation of a site contaminated by an oil spill is often a time consuming and expensive process. Methods for remediating sites contaminated by an oil spill include:

i) containing the oil spill with booms and collecting the oil from the water surface using skimmer equipment and/or absorbent pads;

ii) using dispersants to break up the oil and speed its natural biodegradation; and

iii) introducing microorganisms that can metabolise the oil, along with surfactants, micronutrients and bio-stimulants.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Disclosed herein is a material for remediation of a site contaminated by an oil spill, the material comprising:

granules of an at least semi-open cell polymeric foam, the granules being less than 10 cm³ in size;

wherein ingredients from which the foam is formed comprise acrylonitrile butadiene rubber as a major constituent thereof by weight.

In addition to acrylonitrile butadiene rubber, the ingredients may also comprise another low polarity polymer. The other low polarity polymer may be polyethylene. The ratio of the amount of acrylonitrile butadiene rubber to the amount of the other low polarity polymer, by weight, in the ingredients may be between 3:1 and 1:1, between 2.5:1 and 1.5:1 or around 2:1.

The granules may be less than 5 cm³, less than 3 cm³, less than 2 cm³ or less than 1 cm³ in size. The granules may, for example, be between 1 mm³ and 1 cm³ in size.

The ingredients may also comprise one or more of: a blowing agent, a cross-linking agent, a plasticiser, a stabiliser, an accelerator, a flame retardant, a lubricating agent and one or more fillers. For example, the blowing agent, cross-linking agent, plasticiser, stabiliser, accelerator, flame retardant, lubricating agent and one or more fillers may comprise ingredients selected from the group consisting of: azodicarbonamide, aluminium hydroxide, talc, dinonyl phthalate (DNP), epoxidized soya bean oil (EBSO), diantimony trioxide, zinc borate, chlorinated paraffin oil, paraffin wax, polyethylene glycol and carbon black.

The foam may initially be a closed cell foam and may be converted into semi-open cell or open cell form by one or more of: cutting/shearing, crushing, stretching and/or aerating the closed cell foam. The foam may initially be non-granular and may be formed into granules. The granularisation process may provide the one or more of: cutting/shearing, crushing, stretching and/or aerating that converts the closed cell foam into a semi-open cell or open cell foam. The cutting/shearing may comprise forcing the foam between spaced apart cutting surfaces.

Also disclosed is an apparatus for remediation of a site contaminated by an oil spill, the apparatus comprising:

material as defined in as defined in paragraph [0007] above, optionally also including any one or more of the features defined in paragraphs [0008] to [0011] above, the material being encapsulated in a porous capsule.

The porous capsule may be around 0.1 m³ to 1 m³ in size. The porous capsule may be formed from a conformable material. The porous capsule may take the form of a pillow, matt or boom.

Also disclosed is a method of manufacturing a material for remediation of a site contaminated by an oil spill, the method comprising:

forming a closed cell polymeric foam, wherein ingredients from which the foam is formed comprise acrylonitrile butadiene rubber as a major constituent thereof by weight;

converting the closed cell foam into an at least semi-open cell foam; and

granularising the foam into granules of less than 10 cm³ in size.

The closed cell foam may be converted into the at least semi-open cell foam by one or more of: cutting/shearing, crushing, stretching and/or aerating the closed cell foam. The granularisation process may provide the one or more of: cutting/shearing, crushing, stretching and/or aerating that converts the closed cell foam into an at least semi-open cell foam. The cutting/shearing may comprise forcing the foam between spaced apart cutting surfaces.

In addition to acrylonitrile butadiene rubber, the ingredients may also comprise another low polarity polymer. The other low polarity polymer may be polyethylene. The ratio of the amount of acrylonitrile butadiene rubber to the amount of the other low polarity polymer, by weight, in the ingredients may be between 3:1 and 1:1, between 2.5:1 and 1.5:1 or around 2:1.

The granules may be less than 5 cm³, less than 3 cm³, less than 2 cm³ or less than 1 cm³ in size. The granules may, for example, be between 1 mm³ and 1 cm³ in size.

The ingredients may also comprise one or more of: a blowing agent, a cross-linking agent, a plasticiser, a stabiliser, an accelerator, a flame retardant, a lubricating agent and one or more fillers. For example, the blowing agent, cross-linking agent, plasticiser, stabiliser, accelerator, flame retardant, lubricating agent and one or more fillers may comprise ingredients selected from the group consisting of: azodicarbonamide, aluminium hydroxide, talc, dinonyl phthalate (DNP), epoxidized soya bean oil (EBSO), diantimony trioxide, zinc borate, chlorinated paraffin oil, paraffin wax, polyethylene glycol and carbon black.

Also disclosed is a method of remediating a site contaminated by an oil spill, the method comprising:

providing a material as defined in paragraph [0007] above, optionally also including any one or more of the features defined in paragraphs [0008] to [0011] above; or

providing a material manufactured using the method as defined in paragraph [0014] above, optionally also including any one or more of the features defined in paragraphs [0015] to [0018] above; and

dispensing a quantity of the material at the site contaminated by the oil spill;

allowing the material to sorb oil from the oil spill; and

collecting the material after it has sorbed the oil.

The sorbed oil may be removed from the material, for example by compressing the material or by centrifuging the material. After removal of the oil, the material may be reused for sorbing oil from an oil spill.

The material may be encapsulated in a porous capsule. The porous capsule may be around 0.1 m³ to 1 m³ in size. The porous capsule may be formed from a conformable material The porous capsule may take the form of a pillow, matt or boom. The material from which the porous capsules are formed may be made from or comprise high performance fibres, such as aramid fibres and/or ultra-high molecular weight polyethylene (UHMWPE) fibres.

### BRIEF DESCRIPTION OF DRAWINGS

Non-limiting examples of apparatus and methods embodying principles disclosed herein will now be described with reference to accompanying drawings, in which:

FIG. 1 is a schematic view of an example of an apparatus for remediation of a site contaminated by an oil spill;

FIG. 2 is a plan view of an example of a spinning rotary cutting machine for producing granular material for use in the apparatus of FIG. 1;

FIG. 3 is a schematic site plan for a site undergoing remediation using the apparatus of FIG. 1

FIG. 4 is a plan view of an example of a centrifuge for extracting oil from the apparatus of FIG. 1; and

FIG. 5 is an elevational view of a wringer for extracting oil from the apparatus of FIG. 1.

### DESCRIPTION OF EMBODIMENTS

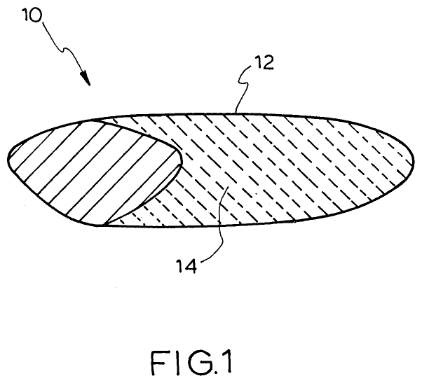

FIG. 1 shows an apparatus 10 for remediation of a site contaminated by an oil spill. The apparatus 10 comprises a porous capsule 12 encapsulating material 14 for sorbing oil from an oil spill. The material 14 comprises granules of an at least semi-open cell polymeric foam, the granules being between 1 mm³ and around 1 cm³ in size. Ingredients from which the polymeric foam is formed comprise acrylonitrile butadiene rubber as a major constituent thereof by weight.

In addition to acrylonitrile butadiene rubber, the ingredients for forming the foam also comprise polyethylene (PE), which is another low polarity polymer. The ratio of the amount of acrylonitrile butadiene rubber to the amount of PE, by weight, in the ingredients is approximately 2:1. The applicant has found that including both acrylonitrile butadiene rubber and PE in the foam increases the sorption performance and chemical resistance of the foam, especially when included in a ratio, by weight, of approximately 2:1.

The ingredients for forming the foam comprise:

| | Proportion |
|---|---|
| Ingredient | (wt %) |
| Talc | 7 |
| Polyethylene (PE) | 18.4 |
| Acrylonitrile-butadiene rubber | 35 |
| Carbon Black | 2.5 |
| Epoxidized soya bean oil | 6.5 |
| AC blowing agent | 10 |
| Aluminium hydroxide | 10 |
| Diantimony trioxide | 1.6 |
| Zinc borate | 1.5 |
| Dinonyl phthalate (DNP) | 5 |
| Paraffin wax | 1.5 |
| Polyethylene glycol | 1 |

The ingredients for forming the foam are extruded and vulcanised to initially form a closed cell polymeric foam. The closed cell foam is then converted into an at least semi-open cell foam, and granularised. The conversion and granularisation are achieved in a single process in which the closed cell foam is forced between spaced apart cutting surfaces, which causes the foam to shear/tear and undergo a degree of stretching. It is presumed that some aeration of the foam also occurs during this shearing/tearing and stretching process. The shearing/tearing, stretching and aerating of the closed cell foam ruptures walls of the closed cells in the foam, thereby converting the foam into a semi-open cell or open cell foam.

The applicant has found that including ESBO in the ingredients for the foam, especially in a proportion as disclosed in the table above, improves the cellular structure of the foam and its oleophilic affinity. The applicant has also found that including aluminum hydroxide in the ingredients for the foam, especially in a proportion as disclosed in the table above, improves the sorption capacity of the foam.

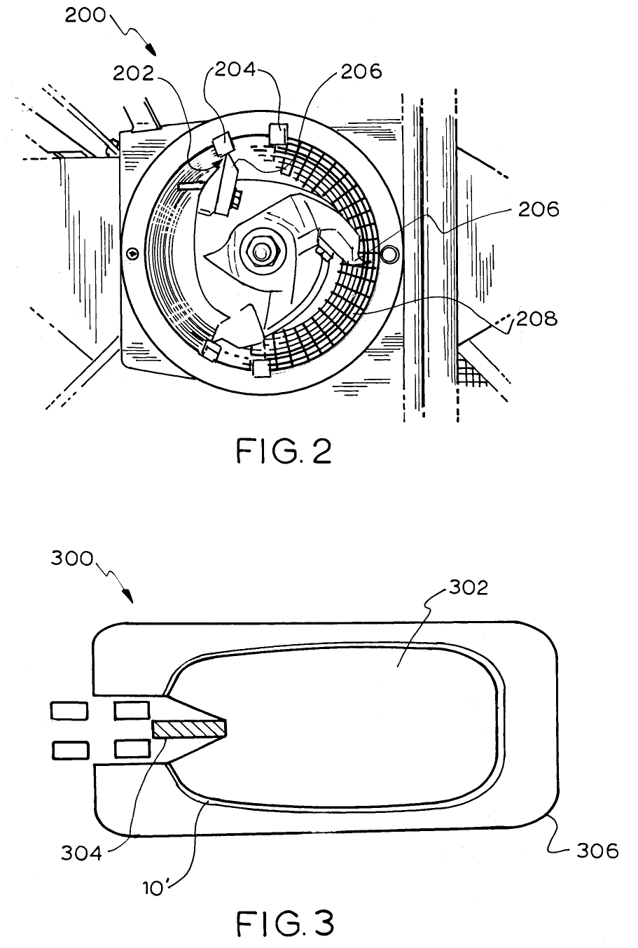

Referring to FIG. 2, there is shown an example of a spinning rotary cutting machine 200 for performing the conversion and granularisation of the initially closed cell foam. Machine 200 has an air gap 202 of between around 0.2 mm to 0.5 mm between two cutting surfaces. A first of the cutting surfaces 204 is fixed and a second of the cutting surfaces 206 is rotatable relative to the first cutting surface. Granules are extracted from the cutting machine 200 through a grate 208 under a slight vacuum. The grate 208 has openings of between around 6 mm and 8 mm. The first cutting surfaces 204 are provided in pairs. The cutting surfaces 204 of each pair are spaced apart by approximately 6-8 cm.

Instead of manufacturing a closed cell nitrile rubber foam from scratch, the present applicant has found that granular material 14 can be produced by processing a pre-existing closed cell nitrile rubber extruded foam material to convert, via the cutting, shearing/tearing, stretching and aerating process described above, the extruded foam material into granules of at least semi-open cell nitrile rubber foam. The present applicant has found that an extruded nitrile rubber foam material produces good quality granular material 14 when granulated using the cutting, shearing/tearing, stretching and aerating process described above.

In the embodiment shown in FIG. 1, the porous capsule is in the form of a pillow having dimensions of approximately 500 mm by 500 mm by 100 mm. However, the porous capsule can also take the form or a matt or boom and can be of any size suitable for the oil spill to be remediated. For example, for larger oil spills, multiple porous capsules of up to around 1 m³ in size may be used, whereas, for smaller oil spills, porous capsules of 0.05 m³ may be used. In the form of a boom, the porous capsule may, for example, have a diameter of between 150 mm and 300 mm and be between 1 m and 6 m long or longer. Such a boom may comprise clips or other forms of anchors to facilitate multiple booms being joined together to achieve a desired length, such as corresponding with the length required to create a perimeter around an oil spill.

Ideally, the porous capsules are formed from a conformable material. Examples of suitable materials for the porous capsules include nylon netting, flyscreen material, geotextile, and woven or matted cloth. In some embodiments, the material from which the porous capsules are formed may be made from or comprise high performance fibres, such as aramid fibres and/or ultra-high molecular weight polyethylene (UHMWPE) fibres.

A site contaminated by an oil spill can be remediated using the material 14 by:

dispensing a quantity of the granular material 14 at the site contaminated by the oil spill;

allowing the material 14 to sorb oil from the oil spill; and

collecting the material 14 after it has sorbed the oil.

The material 14 can be dispensed as unencapsulated loose granules or in the form of apparatus 10.

FIG. 3 shows a schematic plan view of a site 300 comprising an oil spill 302 undergoing remediation using the material 14. A perimeter around the oil spill 302 is created by interconnecting a plurality of interconnected booms 10′ of porous capsules filled with the material 14. A conveyor 304 is provided to dispense and collect granular material 14 to/from the oil spill 302 within the perimeter created by the booms 10′. The conveyor 304 may dispense the material in the form of loose granules and/or in the form of apparatus 10. An outer perimeter control boom 306 comprising a non-porous material with a skirt extending below the water line is provided outside the perimeter created by booms 10′.

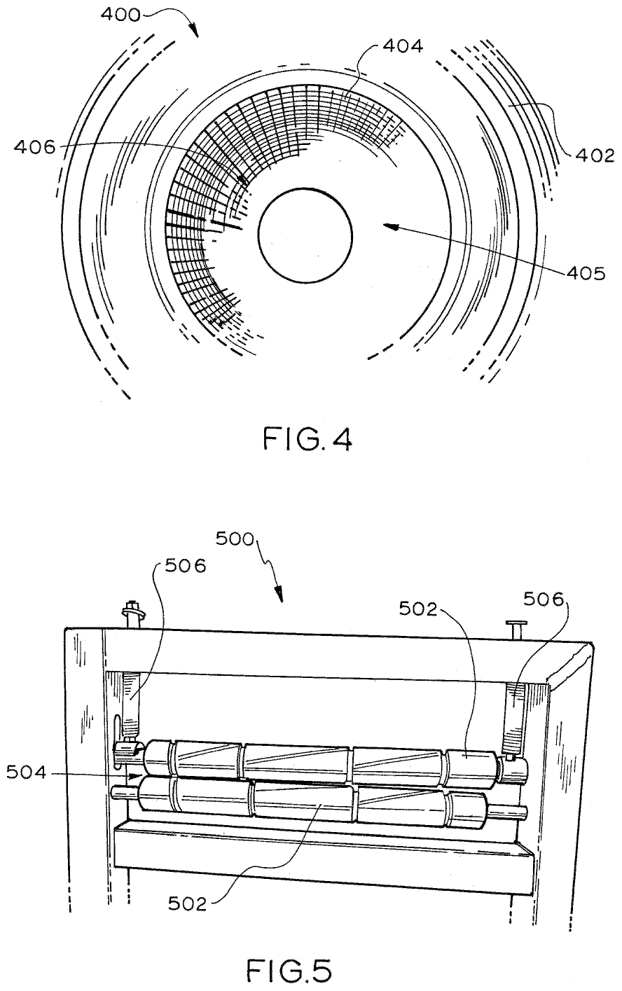

Sorbed oil can be removed from the material 14 by compressing and/or centrifuging the material 14. An exemplary centrifuge 400 for extracting oil from the material 14 is shown in FIG. 4. Centrifuge 400 comprises an outer cylindrical casing 402 having a cylindrical strainer 404 located centrally therein. The strainer 404 has openings sized to retain the granular material 14 within an interior 405 of the strainer but to allow oil in the granular material 14 to pass into an annulus 406 defined between the strainer 404 and casing 402 as the centrifuge rotates. An exemplary wringer 500 for extracting oil from the material 14 is shown in FIG. 5. The wringer 500 comprises opposing rollers 502 defining a nip 504 therebetween through which the material 14 is squeezed to extract the oil. Wringer 500 comprises a compression spring 506 for biasing the rollers 502 toward one another and to control the magnitude of compression applied to the material 14 as is passes through nip 504. In the wringer example shown in FIG. 4, the rollers 502 are vented rubber rollers. The material 14 may be centrifuged and/or compressed in loose form or in an encapsulated form, such as that of apparatus 10, 10′ where the material 14 is enclosed in porous capsule 12. Wringer 500 is particularly useful for compressing elongate embodiments of apparatus, such as booms 10′. In such embodiments, booms 10′ may be drawn through wringer 500 onsite to remove sorbed oil from apparatus 10, 10′ and thereafter immediately redeployed. In embodiments in which sorbed oil is removed from apparatus 10, 10′ using wringer 500, the material from which the porous capsules 14 are formed may be made from or comprise high performance fibres, such as aramid fibres and/or ultra-high molecular weight polyethylene (UHMWPE) fibres.

After removal of the oil, the material 14 may be repeatedly reused for sorbing oil from an oil spill. The oil recovered from the material 14 may be collected for recycling.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible variations and/or modifications include, but are not limited to:
the PE being replaced with another low polarity polymer;
the ratio of acrylonitrile butadiene rubber to PE or alternative low polarity polymer may be another ratio between 3:1 and 1:1, such as a ratio between 2.5:1 and 1.5:1;
the granules of the material 14 of larger size, such as between 1 cm³ and 2 cm³, between 2 cm³ and 3 cm³ or between 3 cm³ and 5 cm³, or larger;
the closed cell foam may be converted into an at least semi-open cell foam by crushing instead of by tearing/shearing and aerating; and/or
the rollers 502 may be formed from a material other than rubber and/or may not be vented.

1. A material for remediation of a site contaminated by an oil spill, the material comprising:
granules of an at least semi-open cell polymeric foam, the granules being less than 10 cm³ in size;
wherein ingredients from which the foam is formed comprise acrylonitrile butadiene rubber as a major constituent thereof by weight.

2. The material of claim 1, wherein, in addition to acrylonitrile butadiene rubber, the ingredients also comprise another low polarity polymer.

3. The material of claim 2, wherein the other low polarity polymer is polyethylene.

4. The material of claim 2, wherein the ratio of the amount of acrylonitrile butadiene rubber to the amount of the other low polarity polymer, by weight, in the ingredients is between 3:1 and 1:1.

5. The material of claim 4, wherein the ratio is between 2.5:1 and 1.5:1.

6. The material of claim 5, wherein the ratio is around 2:1.

7. The material of claim 1, wherein the granules are less than 5 cm³, less than 3 cm³, less than 2 cm³ or less than around 1 cm³ in size.

8. The material of claim 7, wherein the granules are between 1 mm³ and 1 cm³ in size.

9. The material of claim 1, wherein the ingredients comprise one or more of: a blowing agent, a cross-linking agent, a plasticiser, a stabiliser, an accelerator, a flame retardant, a lubricating agent and one or more fillers.

10. The material of claim 1, wherein the ingredients comprise one or more ingredients selected from the group consisting of: azodicarbonamide, aluminium hydroxide, talc, dinonyl phthalate (DNP), epoxidized soya bean oil (EBSO), diantimony trioxide, zinc borate, chlorinated paraffin oil, paraffin wax, polyethylene glycol and carbon black.

11. An apparatus for remediation of a site contaminated by an oil spill, the apparatus comprising:
the material of claim 1, the material being encapsulated in a porous capsule.

12. The apparatus of claim 11, wherein the porous capsule is formed from a high performance textile material, such as a textile material made from or comprising aramid fibres and/or ultra-high molecular weight polyethylene (UHMWPE) fibres.

13. A method of manufacturing a material for remediation of a site contaminated by an oil spill, the method comprising:
forming a closed cell polymeric foam, wherein ingredients from which the foam is formed comprise acrylonitrile butadiene rubber as a major constituent thereof by weight;
converting the closed cell foam into an at least semi-open cell foam; and
granularising the foam into granules of less than 10 cm³ in size.

14. The method of claim 13, wherein the closed cell foam is converted into the at least semi-open cell foam by one or more of: cutting/shearing, crushing, stretching and/or aerating the closed cell foam.

15. The method of claim 14, wherein granularisation of the foam also provides one or more of the: cutting/shearing, crushing, stretching and/or aerating that converts the closed cell foam into an at least semi-open cell foam.

16. A method of remediating a site contaminated by an oil spill, the method comprising:
providing a material for remediation of a site contaminated by an oil spill, the material comprising: granules of an at least semi-open cell polymeric foam, the granules being less than 10 cm³ in size; wherein ingredients from which the foam is formed comprise acrylonitrile butadiene rubber as a major constituent thereof by weight; or
providing material for remediation of a site contaminated by an oil spill, said material manufactured using a method comprising:
forming a closed cell polymeric foam, wherein ingredients from which the foam is formed comprise acrylonitrile butadiene rubber as a major constituent thereof by weight;
converting the closed cell foam into an at least semi-open cell foam; and
granularising the foam into granules of less than 10 cm³ in size; and
said method of remediating a site contaminated by an oil spill further comprising:
dispensing a quantity of the material at the site contaminated by the oil spill;
allowing the material to sorb oil from the oil spill; and
collecting the material after it has sorbed the oil.

17. The method of claim 16, comprising removing the sorbed oil from the material.

18. The method of claim 17, wherein removing the sorbed oil from the material comprises one of compressing the material and centrifuging the material.

19. The method of claim 17, wherein, after removal of the sorbed oil from the material, the material is reused to sorb oil from an oil spill.

20. The method of claim 16, wherein the material is provided in an apparatus for remediation of a site contaminated by an oil spill, the apparatus comprising:
said material for remediation of a site contaminated by an oil spill, the material being encapsulated in a porous capsule.
